(19) United States
(12) Patent Application Publication
(10) Pub. No.: US 2024/0400895 A1
(43) Pub. Date: Dec. 5, 2024

(54) SEMICONDUCTOR NANOPARTICLES, METHOD FOR PRODUCING SEMICONDUCTOR NANOPARTICLES, AND LIGHT EMITTER

(71) Applicants: National University Corporation Tokai National Higher Education and Research System, Nagoya-shi (JP); Murata Manufacturing Co., Ltd., Nagaokakyo-shi (JP)

(72) Inventors: Tsukasa TORIMOTO, Nagoya-shi (JP); Tatsuya KAMEYAMA, Nagoya-shi (JP); Junya KUBO, Nagoya-shi (JP); Norikazu FUJIHIRA, Nagaokakyo-shi (JP)

(21) Appl. No.: 18/800,594

(22) Filed: Aug. 12, 2024

Related U.S. Application Data
(63) Continuation of application No. PCT/JP2022/047942, filed on Dec. 26, 2022.

(30) Foreign Application Priority Data
Feb. 16, 2022 (JP) 2022-022208
Aug. 24, 2022 (JP) 2022-133382

(51) Int. Cl. C09K 11/66; B82Y 20/00; B82Y 40/00; C01G 17/00

(52) U.S. Cl. CPC C09K 11/662; C01G 17/006; C09K 11/661; B82Y 20/00; B82Y 40/00; C01P 2002/50; C01P 2004/04; C01P 2004/64; C01P 2006/60

(57) ABSTRACT

Semiconductor nanoparticles that include a compound semiconductor mainly containing a Ag component, a Ge component, and a S component, wherein a content ratio of the Ag component to the Ge component is 1.0 or more and less than 7.5, in terms of molar ratio, and an average particle size of the semiconductor nanoparticles is 9 nm or less

### CROSS REFERENCE TO RELATED APPLICATIONS

The present application is a continuation of International application No. PCT/JP2022/047942, filed Dec. 26, 2022, which claims priority to Japanese Patent Application No. 2022-022208, filed Feb. 16, 2022, and Japanese Patent Application No. 2022-133382, filed Aug. 24, 2022, the entire contents of each of which are incorporated herein by reference.

### FIELD OF THE DISCLOSURE

The present disclosure relates to semiconductor nanoparticles, a method for producing semiconductor nanoparticles, and a light-emitting body. More specifically, the present disclosure relates to semiconductor nanoparticles made of a compound semiconductor mainly containing a Ag component, a Ge component, and a S component, a method for producing the semiconductor nanoparticles, and a light-emitting body containing the semiconductor nanoparticles.

### BACKGROUND ART

Compound semiconductors containing a combination of two or more different types of elements have been drawing attention because various properties can be obtained. In particular, semiconductor nanoparticles that are compound semiconductors in the form of nanoparticles are essential materials as light-emitting substances these days. Various beneficial properties can be obtained by changing the element content ratio and/or atomizing the nanoparticles to a size of 10 nm or less to allow for exhibition of quantum size effect. From this perspective, research and development are actively conducted in prospect of application of such semiconductor nanoparticles to various fields such as consumer, medical, and healthcare pharmaceutical products.

For example, Non-Patent Literature 1 discloses the structure and properties of Qdot nanocrystals (Qdot is a trade name) produced by Thermo Fisher Scientific.

Specifically, Non-Patent Literature 1 discloses nanocrystals having a core-shell structure including a core made of CdSe or CdTe and a shell made of ZnS, in which a surface of ZnS is coated with a polymer compound containing a carboxylate group (—COO) (see Non-Patent Literature 1, FIG. 6.6.1, and “Structural Properties”).

According to Non-Patent Literature 1, an emission spectrum in which a peak wavelength varies in the range of 525 to 800 nm can be obtained by controlling the core size of the nanocrystals, and the nanocrystals emit light at a shorter wavelength as the particle size becomes smaller. Thus, according to Non-Patent Literature 1, it may be possible to obtain nanocrystals having various emission properties by varying the particle size, without changing the composition (see Non-Patent Literature 1, FIG. 6.6.5, “Spectroscopic Properties”).

In addition, Patent Literature 1 proposes a light-emitting body formed of nanoparticles made of a compound semiconductor containing a Ag component, a In component, and a Se component, wherein the peak wavelength of the emission intensity is in the range of 700 nm to 1400 nm and the half width of the peak wavelength is 100 nm or less.

In Patent Literature 1, a steep and sharp emission spectrum with a half width of 100 nm or less is obtained in the near infrared region of 700 nm to 1400 nm. Patent Literature 1 provides a light-emitting body having high light transmittance particularly in the wavelength range of 700 to 1000 nm which is referred to as the “biological window”. Patent Literature 1 aims to obtain a light-emitting body suitable for biological constituent substance labeling agents (biomarkers).

Patent Literature 2 proposes a light-emitting body containing nanoparticles made of a compound semiconductor containing at least a Ag component, an In component, and a Se component, wherein the nanoparticles each having a hydrophilic coating formed on its surface are dispersed in water, the peak wavelength of the emission intensity is in the range of 650 nm to 1000 nm, and the half width of the peak wavelength is 100 nm or less.

In the light-emitting body of Patent Literature 2, the nanoparticles each having a surface imparted with hydrophilicity are dispersed in water. This prevents adsorption of a cytotoxic, non-polar organic solvent on a living tissue and results in a steep and sharp emission spectrum with a half width of 100 nm or less in the near infrared region of 650 nm to 1000 nm. Moreover, in Patent Literature 2, a coating is formed on a surface of each nanoparticle to deactivate the surface, achieving an emission quantum yield of 10% or more.
Patent Literature 1: WO 2017/126164 (claim 1, paragraph [0033], Table 1, and elsewhere)
Patent Literature 2: WO 2020/246297 (claims 1 and 3, paragraph [0024], Table 1, and elsewhere)
Non-Patent Literature 1: “Qdot Nanocrystals-Section 6.6”, [online], Thermo Fisher Scientific, Inc., [searched on Jan. 11, 2022], internet <URL: https://www.thermofisher.com/jp/ja/home/references/molecular-probes-the-handbook/ultrasensitive-detection-technology/qdot-nanocrystal-technology.html>

### SUMMARY OF THE DISCLOSURE

The prior art literatures described above disclose the presence of a Cd component, a Se component, and an In component, which are toxic, in the nanoparticles, which requires, toxic control and health management of manufacturing workers, for example, thus imposing restrictions on applications to practical fields such as consumer products and medical and healthcare pharmaceutical products.

Specifically, in Non-Patent Literature 1, the core material of the nanocrystals contains a Cd component that is known as a harmful substance, causing a large environmental impact. Application of such nanocrystals to various fields including the biomedical field poses problems.

Patent Literatures 1 and 2 disclose the presence of a Se component and an In component, which are inherently toxic. Specifically, while the Se component constitutes a part of an enzyme or protein in vivo and acts as an antioxidant, the Se component is toxic, and its chronic overdose can cause toxic symptoms. Thus, the Se component needs to be controlled and handled as a toxic substance. The In component had been considered as a relatively safe substance, but its toxicity has been confirmed in recent years. In particular, the In component requires health management of manufacturing workers, and has problems in terms of safety and handling, such as requiring health management over an extended period.

Thus, as alternatives to these components such as Cd, Se, and In, there is a demand for novel semiconductor nanoparticles that require no strict toxic control and no strict health management of manufacturing workers or the like, that are highly safe and easy to handle, and that can be easily applied to practical fields such as consumer products and medical and healthcare pharmaceutical products.

The present disclosure was made in view of the above circumstances and aims to provide safe and easy-to-handle semiconductor nanoparticles capable of emitting light in the near infrared region, a method for producing the semiconductor nanoparticles, and a light-emitting body applicable to various fields such as consumer products and medical and healthcare pharmaceutical products with the use of the semiconductor nanoparticles.

The present inventors conducted extensive studies on compound semiconductors mainly containing a Ag component, a Ge component, and a S component, as alternatives to Cd, In, or Se, which require no strict regulations on toxic control and health management of manufacturing workers, and which are relatively easy to handle and highly safe. As a result, the present inventors found that it is possible to achieve an average particle size of 9 nm or less at which the quantum size effect can be exhibited, by adjusting the amount of the Ag component among the above components to be smaller than its amount in the stoichiometric ratio and setting the content ratio of the Ag component to the Ge component to 1.0 or more and less than 7.5 in terms of molar ratio. The present inventors found that it is possible to produce semiconductor nanoparticles capable of emitting light in the near infrared region.

The present disclosure was made based on the above findings. The semiconductor nanoparticles according to the present disclosure are made of a compound semiconductor mainly containing a Ag component, a Ge component, and a S component, wherein a content ratio of the Ag component to the Ge component is 1.0 or more and less than 7.5 in terms of molar ratio, and an average particle size of the semiconductor nanoparticles is 9 nm or less.

Here, the term “average particle size” refers to the arithmetic mean of equivalent circle diameters of the particles.

Thus, semiconductor nanoparticles can be obtained that require no toxic control and no health management of manufacturing workers over an extended period, that are highly safe and easy to handle, that can emit light in the near infrared region, and that have a controllable emission wavelength.

In the semiconductor nanoparticles of the present disclosure, the content ratio of the Ag component to the Ge component is preferably 1.8 or more and 7.3 or less in terms of molar ratio.

In the semiconductor nanoparticles of the present disclosure, a difference between a maximum particle size and a minimum particle size of the semiconductor nanoparticles is preferably 3 nm or less.

Thus, high-quality semiconductor nanoparticles with a uniform particle size can be obtained.

Further, the semiconductor nanoparticles of the present disclosure can preferably emit light in the wavelength range of 700 to 1000 nm.

Since the semiconductor nanoparticles emit light in the near infrared region of 700 to 1000 nm, it is possible to obtain semiconductor nanoparticles having high light transmittance, which, even when used to emit light to a living body, do not affect the human body.

Meanwhile, the above-described compound semiconductor consists of ultrafine particles having an average particle size of 9 nm or less, and atoms are present in large quantities on particle surfaces of the compound semiconductor, so that many defects are present on the particle surfaces. Energy loss occurs due to surface defects, which may result in poor emission properties.

Yet, as a result of extensive studies, the present inventors found that when a core-shell structure is formed by coating the surfaces of the particles made of the compound semiconductor with a material having a band gap energy greater than that of the compound semiconductor, the core-shell structure improves the emission properties.

Specifically, in the semiconductor nanoparticles of the present disclosure, preferably, the semiconductor nanoparticles have a core-shell structure including a core particle comprising the compound semiconductor and a coating layer comprising a material having a band gap energy greater than that of the compound semiconductor on a surface of the core particle.

Thus, the coating layer can cover the surface defects of the core particles and can reduce energy loss. Moreover, since the band gap energy of the coating layer is greater than the band gap energy of the core particles, light can be released without loss of emission from the core particles, making it possible to obtain semiconductor nanoparticles in which the emission properties can be improved.

In the semiconductor nanoparticles of the present disclosure, the material of the coating layer preferably comprises a compound mainly containing at least one element Z1 selected from the group consisting of elements of Group 12, Group 13, and Group 14 of the periodic table and at least one element Z2 selected from the group consisting of elements of Group 16 of the periodic table.

The compound containing the element Z1 and the element Z2 described above has been widely used as various types of shell materials. Since the compound has a band gap energy greater than that of the core particles, the loss of emission from the core particles can be prevented, and the emission properties can be easily improved.

Further, in the semiconductor nanoparticles of the present disclosure, the element Z1 preferably includes at least one selected from the group consisting of Zn, Ga, Sn, and Ge, and the element Z2 preferably includes at least one selected from the group consisting of S and O.

In the semiconductor nanoparticles of the present disclosure, the coating layer preferably includes multiple coating layers in a layered form on the surface of each of the semiconductor nanoparticles.

This makes it possible to densify the coating layer, so that the energy loss can be more effectively reduced, and the emission properties can be further improved.

Further, the present inventors conducted extensive studies on the method for producing the semiconductor nanoparticles. As a result, they found that when a Ag—Ge—S mixture solution prepared such that its content ratio of Ag to Ge in the final product would be 1.0 or more and less than 7.5 in terms of molar ratio is reacted at 150° C. or higher and lower than 250° C., preferably 220° C. or lower, a particle formation reaction effectively proceeds, and semiconductor nanoparticles having an average particle size of 9 nm or less can be easily obtained.

Specifically, the method for producing the semiconductor nanoparticles according to the present disclosure includes: weighing a Ag compound, a Ge compound, and a S compound such that a content ratio of the Ag component to the Ge component in a compound semiconductor of the semiconductor nanoparticles to be produced is 1.0 or more and less than 7.5 in terms of molar ratio; dissolving the weighed compounds in a solvent so as to produce a Ag—Ge—S mixture solution; and heating the Ag—Ge—S mixture solution at a reaction temperature of 150° C. or higher and lower than 250° C. so as to produce the semiconductor nanoparticles having an average particle size of 9 nm or less.

Thus, the particle formation reaction effectively proceeds, and semiconductor nanoparticles having an average particle size of 9 nm or less can be easily obtained.

In the method for producing semiconductor nanoparticles of the present disclosure, the reaction temperature is preferably 220° C. or lower.

In the method for producing semiconductor nanoparticles of the present disclosure, further comprising dispersing the semiconductor nanoparticles in a non-polar solvent, and the non-polar solvent is preferably chloroform.

Thus, semiconductor nanoparticles that are stably dispersed in a non-polar solvent such as chloroform can be obtained.

In the method for producing semiconductor nanoparticles of the present disclosure, the Ag compound preferably includes silver N,N-diethyldithiocarbamate.

Further, in the method for producing semiconductor nanoparticles of the present disclosure, the Ge compound preferably includes a reaction product of a hydroxy acid and a germanium oxide, and the hydroxy acid preferably includes glycolic acid.

Further, in the method for producing semiconductor nanoparticles of the present disclosure, the S compound preferably includes thiourea.

In the method for producing semiconductor nanoparticles of the present disclosure, the solvent preferably includes a combination of an aliphatic amine and a lipid-soluble thiol, the combination having a boiling point higher than the reaction temperature.

Thus, the Ag compound, the Ge compound, and the S compound are dissolved in a high boiling point solvent that is stable at high temperatures, and a chemically stable Ag—Ge—S mixture solution can be produced.

In the method for producing semiconductor nanoparticles of the present disclosure, the aliphatic amine preferably includes oleylamine.

In the method for producing semiconductor nanoparticles of the present disclosure, the lipid-soluble thiol preferably includes 1-dodecanethiol.

Further, in the method for producing semiconductor nanoparticles of the present disclosure, preferably, multiple ingredient-containing compounds for forming a coating layer having a band gap energy greater than that of the compound semiconductor are provided, and the compound semiconductor and the multiple ingredient-containing compounds are mixed together and heated to form a coating layer on a surface of a core particle comprising the compound semiconductor so as to produce core-shell structured semiconductor nanoparticles.

Thus, core-shell structured semiconductor nanoparticles with improved emission properties can be efficiently produced.

In the method for producing semiconductor nanoparticles of the present disclosure, the multiple ingredient-containing compounds preferably include a Z1 compound containing at least one element Z1 selected from the group consisting of elements of Group 12, Group 13, and Group 14 of the periodic table and a Z2 compound containing at least one element Z2 selected from the group consisting of elements of Group 16 of the periodic table. Preferably, the Z1 compound includes a Zn compound such as bis(2,4-pentanedionato)zinc(II), and the Z2 compound includes a S compound such as thiourea.

In the method for producing semiconductor nanoparticles of the present disclosure, the core-shell structured semiconductor nanoparticles are also preferably dispersed in a non-polar solvent such as chloroform.

The light-emitting body according to the present disclosure contains the semiconductor nanoparticles.

Thus, the light-emitting body is capable of emitting light in the near infrared region, so that the morphology of living tissue can be observed by, for example, combining the light-emitting body with the living tissue and irradiating the living tissue with excitation light from the outside.

The semiconductor nanoparticles of the present disclosure are made of a compound semiconductor mainly containing a Ag component, a Ge component, and a S component, wherein a content ratio of the Ag component to the Ge component is 1.0 or more and less than 7.5 in terms of molar ratio, and an average particle size is 9 nm or less. Thus, the present disclosure can provide semiconductor nanoparticles that require no strict regulations on toxic control and no strict health management of manufacturing workers, that are highly safe and easy to handle, that can emit light in the near infrared region, and that have a controllable emission wavelength.

The present disclosure can also provide a method for producing semiconductor nanoparticles made of a compound semiconductor mainly containing a Ag component, a Ge component, and a S component, the method including: weighing a precursor Ag compound, a precursor Ge compound, and a precursor S compound such that a content ratio of the Ag component to the Ge component Ag/Ge in the semiconductor nanoparticles is 1.0 or more and less than 7.5 in terms of molar ratio and dissolving the weighed compounds in a solvent so as to produce a Ag—Ge—S mixture solution; and heating the Ag—Ge—S mixture solution at a reaction temperature of 150° C. or higher and lower than 250° C. so as to produce semiconductor nanoparticles having an average particle size of 9 nm or less. Thus, the particle formation reaction effectively proceeds, and semiconductor nanoparticles having an average particle size of 9 nm or less can be easily obtained.

The light-emitting body of the present disclosure contains the semiconductor nanoparticles. Thus, the light-emitting body is capable of emitting light in the near infrared region, so that the morphology of living tissue can be observed by, for example, combining the light-emitting body with the living tissue and irradiating the living tissue with excitation light from the outside.

### BRIEF DESCRIPTION OF THE DRAWINGS

FIG. 1 is a schematic view showing an embodiment (first embodiment) of a semiconductor nanoparticle according to the present disclosure.

FIG. 2 is a schematic view showing a second embodiment of the semiconductor nanoparticles according to the present disclosure.

FIG. 3 is a schematic view showing a modified example of the second embodiment.

FIG. 4 is a TEM image of sample No. 1.

FIG. 5 is a TEM image of sample No. 2.

FIG. 6 is a TEM image of sample No. 3.

FIG. 7 is a TEM image of sample No. 4.

FIG. 8 is a TEM image of sample No. 5.

FIG. 9 is a TEM image of sample No. 6.

FIG. 10 is a TEM image of sample No. 9.

FIG. 11A-FIG. 11C include photos of samples of sample Nos. 2, 8, and 9.

FIG. 12 is a view showing an absorption spectrum profile of sample No. 1.

FIG. 13 is a view showing an absorption spectrum profile of sample No. 2.

FIG. 14 is a view showing an absorption spectrum profile of sample No. 3.

FIG. 15 is a view showing an absorption spectrum profile of sample No. 4.

FIG. 16 is a view showing an absorption spectrum profile of sample No. 5.

FIG. 17 is a view showing an absorption spectrum profile of sample No. 6.

FIG. 18 is a view showing an emission spectrum profile of sample No. 1.

FIG. 19 is a view showing an emission spectrum profile of sample No. 2.

FIG. 20 is a view showing an emission spectrum profile of sample No. 3.

FIG. 21 is a view showing an emission spectrum profile of sample No. 4.

FIG. 22 is a view showing an emission spectrum profile of sample No. 5.

FIG. 23 is a view showing an emission spectrum profile of sample No. 6.

FIG. 24 is a view showing a relationship between reaction temperature and an absorption spectrum profile of sample No. 2.

FIG. 25 is a view showing a relationship between reaction temperature and an emission spectrum profile of sample No. 2.

FIG. 26 is a TEM image of sample No. 12.

FIG. 27 is a particle size distribution histogram of sample No. 12.

FIG. 28 is a view showing absorption spectrum profiles of sample No. 11 and sample No. 12.

FIG. 29 is a view showing emission spectrum profiles of sample No. 11 and sample No. 12.

### DESCRIPTION OF THE PREFERRED EMBODIMENTS

Next, embodiments of the present disclosure are described in detail.

### First Embodiment

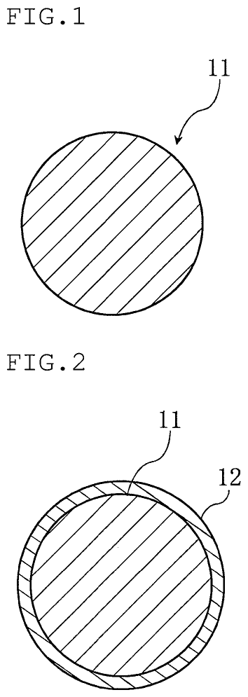

FIG. 1 is a schematic view showing an embodiment (first embodiment) of a semiconductor nanoparticle according to the present disclosure. Semiconductor nanoparticles 11 of the present embodiment contain a compound semiconductor mainly containing a Ag component, a Ge component, and a S component (hereinafter referred to as “Ag—Ge—S-based compound semiconductor”). In the semiconductor nanoparticles, a content ratio of the Ag component to the Ge component (hereinafter referred to as “molar ratio of Ag/Ge”) is 1.0 or more and less than 7.5 in terms of molar ratio, and an average particle size of the semiconductor nanoparticles is 9 nm or less.

Thus, semiconductor nanoparticles can be obtained that can emit light in the near infrared region with a wavelength of 700 to 1000 nm and that have a controllable emission wavelength, without using high environmental impact elements that require strict regulations on toxic control and health management of manufacturing workers.

Specifically, while compound semiconductors are essential materials as light-emitting substances, as described in “Technical Problem”, a highly toxic Cd component, a Se component that causes toxic symptoms when overdosed, or an In component that requires long-term health management of manufacturing workers have been used as constituent substances of compound semiconductors. These compound semiconductors are poor in terms of safety and handling.

Meanwhile, a compound semiconductor containing a Ag component, a Ge component, and a S component whose stoichiometric composition is represented by Ag₈GeS₆ has been known. These component elements do not require strict management and are highly safe and easy to handle, unlike Cd, Se, and In. Thus, semiconductor nanoparticles made of a Ag—Ge—S-based compound semiconductor are promising as an alternative to AgInSe₂ and CdSe.

Thus, in the present embodiment, the semiconductor nanoparticles are made of a Ag—Ge—S-based compound semiconductor, and the molar ratio of Ag to Ge is set to 1.0 or more and less than 7.5 for the following reasons.

In recent years, this type of semiconductor nanoparticles has been drawing attention in terms of application to biological constituent substance labeling agents (biomarkers). In this case, it has been considered preferable to cause a fluorescent phenomenon in the near-infrared region in the wavelength range of 700 to 1700 nm. Specifically, biological constituents, such as hemoglobin, have high absorption in the visible light region in the wavelength of 400 nm or more and less than 700 nm that is shorter than the wavelength in the near-infrared region. An increase in wavelength over 1700 nm leads to an increase in absorption by water, making it difficult for light to pass through a living body at a high efficiency. In contrast, the light transmittance through a living body is high in the near-infrared region with a wavelength of 700 to 1700 nm, particularly the range with a wavelength of 700 to 1000 nm, so that the above wavelength region is considered to be suitable for bioimaging technology.

As described above, a Ag—Ge—S-based compound semiconductor has a stoichiometric composition of Ag₈GeS₆ and a stoichiometric molar ratio of Ag/Ge of 8. At the same time, the absorption edge wavelength of Ag₈GeS₆ is about 900 nm. Thus, the emission wavelength, particularly the maximum wavelength may exceed 1000 nm. When such a material is used to emit light to a living tissue, it may be difficult to obtain high-precision biological information.

Specifically, when photon energy is imparted to this type of semiconductor nanoparticles, the semiconductor nanoparticles absorb light, ground-state electrons in the valence band are excited to a conduction band, and positive holes are formed in the valence band. The excited electrons are pulled by the Coulomb force toward the ground-state valence band where the positive holes are present, and the electrons reunite with the positive holes, thus emitting light. In this case, the emission wavelength is preferably as close as possible to the absorption edge wavelength to achieve high-efficiency emission. Yet, usually, a part of the photon energy is expended on vibration energy and the like when the electron is returned from the excitation state to the valence band. Thus, a shift called Stokes shift occurs between the absorption wavelength and the emission wavelength. Therefore, the emission wavelength of the semiconductor nanoparticles is close to the long wavelength side, compared to the absorption edge wavelength. Yet, since the absorption edge wavelength of a material having a stoichiometric molar ratio of Ag/Ge of 8 is about 900 nm as described above, the emission wavelength, particularly the maximum wavelength may exceed 1000 nm. When such a material is used to emit light to a living tissue, the light transmittance through a living body is poor, so that it may be difficult to obtain high-precision biological information.

In contrast, when the molar ratio of Ag/Ge is adjusted such that the molar amount of Ag is smaller than its amount in the stoichiometric ratio, the absorption edge wavelength can be shifted to about 650 to 800 nm toward the short wavelength side. Thus, light can be emitted in the wavelength range of 700 to 1000 nm where the light transmittance through a living body is high.

However, when the molar ratio of Ag/Ge is less than 1.0, the amount of the Ag component is extremely small. This may hinder the nanoparticle formation reaction, and a Ag—Ge—S-based compound semiconductor may not be obtained.

In contrast, when the molar ratio of Ag/Ge is 7.5 or more, the emission quantum yield (percentage of photons emitted and released among photons absorbed by nanoparticles) is less than 0.5%, which may cause a decrease in emission efficiency.

Thus, in the present embodiment, the amounts of the Ag component and the Ge component are adjusted to achieve a molar ratio of Ag/Ge of 1.0 or more and less than 7.5, preferably 1.8 or more and 7.3 or less.

Further, in the present embodiment, the semiconductor nanoparticles have an average particle size of 9 nm or less.

Specifically, semiconductor nanoparticles atomized to an average particle size of about 10 nm or less generally exhibit the quantum size effect in which the band gap energy increases along with a decrease in particle size. The light absorption and emission wavelength of such semiconductor nanoparticles can be controlled in a broad range without using a semiconductor material having a different composition.

Thus, in the present embodiment, the reaction conditions such as reaction temperature and reaction time are adjusted such that the semiconductor nanoparticles have an average particle size of 9 nm or less. This allows the semiconductor nanoparticles to exhibit the quantum size effect. The emission wavelength can be varied as needed in the wavelength range of 700 to 1000 nm by changing the average particle size.

The present inventors conducted a reaction between a Ag component and a S component to produce a Ag—S-based compound semiconductor containing no Ge component. As described in detail later in Examples, they observed particle growth and coarsening of the resulting product with an average particle size of more than 9 nm.

The particle size variation in the semiconductor nanoparticles of the present embodiment is controlled such that the difference between the maximum value Dmax and the minimum value Dmin is preferably 3 nm or less, more preferably 2.6 nm or less.

Thus, stable and high-quality semiconductor nanoparticles with a uniform particle size and good dispersibility can be obtained.

The semiconductor nanoparticles of the present embodiment are made of a compound semiconductor mainly containing a Ag component, a Ge component, and a S component, wherein a content ratio of the Ag component to the Ge component is 1.0 or more and less than 7.5 in terms of molar ratio, and an average particle size is 9 nm or less. Thus, the present disclosure can provide semiconductor nanoparticles that require no strict regulations on toxic control and no strict health management of workers, that are highly safe and easy to handle, that can emit light in the near infrared region, and that have a controllable emission wavelength.

Next, an embodiment of the method for producing semiconductor nanoparticles is described in detail.

First, in order to obtain a Ge compound to serve as a Ge source, for example, a hydroxy acid is reacted with a Ge oxide. Here, any hydroxy acid may be used as long as it is a carboxylic acid containing a hydroxy group. For example, glycolic acid (HOCH₂COOH), lactic acid (CH₃CH(OH)COOH), malic acid (HOOCCH(OH)CH₂COOH), glycerol (HOCH₂CH(OH)COOH), and the like can be used. Likewise, any Ge oxide may be used, but usually, germanium (iv) oxide (GeO₂) is preferably used.

A hydroxy acid and a Ge oxide are weighed out to predetermined amounts, and these weighed components are mixed together in high purity water or ultrapure water, and heated and stirred in an oil bath adjusted to a predetermined temperature (e.g., 100° C.), whereby the hydroxy acid is reacted with the Ge oxide, followed by evaporation and drying. Thus, a Ge compound is obtained.

Next, a Ag compound to serve as a Ag source and a S compound to serve as a S source are provided. Here, any Ag compound may be used. For example, organic silver salts such as silver N,N-diethyldithiocarbamate (AgS₂CN(CH₅)₂) (hereinafter, “AgDDTC”) and silver acetate (Ag(OCOCH₃), and inorganic silver salts such as silver nitrate (AgNO₃) and silver sulfate (Ag₂SO₄) can be used. For example, thiourea (SC(NH₂)₂) can be used as the S compound.

Then, the Ag compound, the Ge compound, and the S compound are weighed such that the semiconductor nanoparticles as the final product have a molar ratio of Ag/Ge of 1.0 or more and less than 7.5, preferably 1.8 or more and 7.3 or less.

Next, these weighed compounds are dissolved in a solvent to produce a Ag—Ge—S mixture solution. Here, a solvent that can be preferably used is a chemically stable, high-boiling point solvent having a boiling point higher than the later-described reaction temperature. For example, a high-boiling point mixture solution of an aliphatic amine and a lipid-soluble thiol can be used. Here, examples that can be used as the aliphatic amine include aliphatic amines having 6 or more carbon atoms such as hexylamine (C₆H₁₃NH₂), heptylamine (C₇H₁₅NH₂), octylamine (C₈H₁₇NH₂), nonylamine (C₉H₁₉NH₂), decylamine (C₁₀H₂₁NH₂), dodecylamine (C₁₂H₂₅NH₂), tetradecylamine (C₁₄H₂₉NH₂), pentadecylamine (C₁₅H₃₁NH₂), hexadecylamine (C₁₆H₃₃NH₂), heptadecylamine (C₁₇H₃₅NH₂), octadecylamine (C₁₈H₃₇NH₂), and oleylamine (C₈H₁₇CH═CHC₈H₁₆NH₂). Among these aliphatic amines, oleylamine, which is a liquid at room temperature and has a high boiling point (about 350° C.), can be preferably used.

Examples that can be used as the lipid-soluble thiol include aliphatic thiols, dithiols, and aromatic thiols. Among these lipid-soluble thiols, 1-dodecanethiol (C₁₂H₂₅SH) having a high boiling point (about 270° C.) can be particularly preferably used.

Then, the Ag—Ge—S mixture solution is vacuum degassed, followed by nitrogen purging and heating at a predetermined reaction temperature, whereby a reaction product is obtained. Here, the reaction temperature is preferably 150° C. or higher and lower than 250° C. Specifically, when the reaction temperature is lower than 150° C., the particle formation reaction will be difficult to proceed because the reaction temperature is too low. In contrast, when the reaction temperature is 250° C. or higher, the particle growth is promoted, resulting in coarsened particles. This may make it difficult to obtain dispersed and stable nanoparticles.

Thus, as described above, the reaction temperature is preferably 150° C. or higher and lower than 250° C., more preferably 150° C. or higher and 220° C. or lower.

The reaction time is not limited and can be set to about 5 to 20 minutes, for example. The particle growth can be controlled also by changing the reaction time. Thus, the average particle size can be adjusted in the range of 9 nm or less. When the average particle size is adjusted as described above, the emission wavelength varies due to the quantum size effect, which makes it possible to control the peak wavelength of the emission intensity.

The molar ratio of Ag/Ge can be adjusted by controlling the reaction conditions described above (reaction temperature and reaction time). Specifically, it is possible to control not only the average particle size but also the molar ratio of Ag/Ge within the ranges specified in the present disclosure by changing the reaction conditions, without changing the feeding amounts of the Ag compound, the Ge compound, and the S compound.

Then, the reaction product is cooled to room temperature by being left standing, followed by centrifugation to separate the supernatant from the precipitate. The supernatant is collected, and the precipitate is discarded. A poor solvent such as methanol, ethanol, acetone, or acetonitrile is added to the supernatant to form a precipitate, followed by re-centrifugation. The supernatant is discarded, and the precipitate is collected by separation.

The operation sequentially including addition of a poor solvent, centrifugation, and collection of the precipitate is preferably repeated several times, whereby a high purity precipitate free of impurities of foreign phases and the like can be produced.

Then, the precipitate is dissolved in a non-polar solvent such as chloroform, toluene, or hexane, whereby, the nanoparticles made of the Ag—Ge—S-based compound semiconductor are stably dispersed in the non-polar solvent. Thus, a nanoparticle dispersion can be produced.

As described above, the method for producing semiconductor nanoparticles of the present embodiment includes: weighing a Ag compound, a Ge compound, and a S compound such that a content ratio of a Ag component to a Ge component in semiconductor nanoparticles to be obtained is 1.0 or more and less than 7.5 in terms of molar ratio and dissolving the weighed compounds in a solvent so as to produce a Ag—Ge—S mixture solution; and heating the Ag—Ge—S mixture solution at a reaction temperature of 150° C. or higher and lower than 250° C. so as to produce semiconductor nanoparticles having an average particle size of 9 nm or less. Thus, the particle formation reaction effectively proceeds, and semiconductor nanoparticles having an average particle size of 9 nm or less can be easily obtained.

A light-emitting body containing the semiconductor nanoparticles is capable of emitting light in the near infrared region with a wavelength of 700 to 1000 nm, and thus can be suitably applied as biological substance labeling agents (biomarkers) to bioimaging technology. Specifically, a light-emitting body containing the semiconductor nanoparticles of the present embodiment is allowed to be adsorbed on living tissue, and the light-emitting body is irradiated with near infrared light to allow the light-emitting body to emit light. Then, obtained images are dynamically analyzed to detect biological information, whereby the effects of medications and cell conditions in regenerative medicine, cancer treatment, and the like can be quickly checked.

### Second Embodiment

FIG. 2 is a schematic view showing a second embodiment of the semiconductor nanoparticles according to the present disclosure.

In the second embodiment, the Ag—Ge—S-based compound semiconductor obtained in the first embodiment is formed into the core particles 11, and a coating layer (shell layer) 12 having a band gap energy greater than the band gap energy of the core particles 11 is formed on the surface of each core particle 11, thus forming a core-shell structure. Thus, semiconductor nanoparticles with improved emission properties can be obtained.

Specifically, when photon energy is imparted to a Ag—Ge—S-based compound semiconductor as the core particles 11, the Ag—Ge—S-based compound semiconductor absorbs light, ground-state electrons in a valence band are excited to a conduction band, and positive holes are formed in the valence band, as described in the first embodiment. The excited electrons are pulled by the Coulomb force toward the ground-state valence band where the positive holes are present, and the electrons reunite with the positive holes and attempt to emit light.

However, as described above, the Ag—Ge—S-based compound semiconductor of the present embodiment consists of ultrafine particles having an average particle size of 9 nm or less, and atoms are present in large quantities on the particles surfaces of the compound semiconductor, so that many crystal structure defects are present on the surface of the Ag—Ge—S-based compound semiconductor as the core particles 11. The defects form various energy levels, i.e., defect levels, between the bands. Thus, when electrons excited by light absorption transition from the conduction band to the valence band, the excited electrons return to the valence band while undergoing vibrational relaxation without releasing light due to the defect levels. This may cause non-radiative deactivation in which no light is released even when the electrons that transitioned to the valence band reunite with the positive holes, which may result in poor emission properties. Thus, a further improvement in emission properties requires suppression of the non-radiative deactivation by reducing surface defects on the core particles 11. For that, it is considered preferable to form the coating layer (shell layer) 12 on the surface of each core particle 11 to cover the surface defects.

Yet, when the upper edge of the band gap energy of a shell material forming the coating layer 12 is lower than the lower edge (conduction band lower edge) of the band gap energy of the core particles 11, the excited electrons transition from the conduction band to low energy levels at the upper edge of the band gap of the shell material, and transition from the low energy levels to the ground-state valence band, resulting in loss of emission from the core particles 11.

Thus, in the second embodiment of the present disclosure, the coating layer 12 having a band gap energy greater than the band gap energy of the core particles 11 is formed on the surface of each core particle 11. This can prevent the loss of emission from the core particles 11 and can also effectively cover the surface defects on the core particles 11, so that the non-radiative deactivation can be reduced. This, in turn, can reduce energy loss and improve the emission properties.

The coating layer 12 may be made of any shell material as long as the shell material has a band gap energy greater than the band gap energy of the core particles 11 (Ag—Ge—S-based compound semiconductor) as described above. For example, a compound mainly containing at least one element Z1 selected from the group consisting of elements of Group 12, Group 13, and Group 14 of the periodic table and at least one element Z2 selected from the group consisting of elements of Group 16 of the periodic table can be used. The element Z1 may be at least one selected from the group consisting of Zn, Ga, Sn, and Ge. The element Z2 may be at least one selected from the group consisting of S and O. Ag₈GeS₆, which is a stoichiometric composition of the Ag—Ge—S-based compound semiconductor, has a band gap energy of about 1.45 eV. Thus, ZnS having a band gap energy of about 3.7 eV and Ga₂S₃ having a band gap energy of about 3.4 eV are suitable as shell materials.

Next, a method for producing the semiconductor nanoparticles according to the second embodiment is described in detail.

First, a core particle dispersion made of a Ag—Ge—S-based compound semiconductor is produced by a method and a procedure similar to those in the first embodiment.

Then, a predetermined amount of the core particles is collected from the core particle dispersion, and the particles are sufficiently degassed. Separately, a solvent such as oleylamine is stirred under heating while being vacuum degassed, and is then cooled to room temperature to produce a dry solvent.

Next, multiple ingredient-containing compounds are provided to form the coating layer 12.

Examples that can be used as the ingredient-containing compounds include a Z1 compound containing at least one element Z1 selected from the group consisting of Group 12 including Zn and the like, Group 13 including Ga and the like, and Group 14 including Sn and the like of the periodic table, and a Z2 compound containing at least one element Z2 selected from Group 16 including S, O, and the like of the periodic table.

Among these ingredient-containing compounds, a Zn compound containing Zn and a S compound containing S can be preferably used.

Here, the Zn compound is not limited. Examples that can be preferably used include inorganic acid salts of Zn, such as zinc acetate (Zn(CH₃COO)₂), zinc chloride (ZnCl₂), zinc nitrate (Zn(NO₃)₂), and zinc iodide (ZnI₂), and fatty acid salts of Zn, such as zinc oleate (Zn(C₈H₁₇CH═CHC₇H₁₄COO)₂) and zinc myristate (Zn(C₁₃H₂₇COO)₂). Further, bis(2,4-pentanedionato)zinc(II) shown in formula (1) can be preferably used.

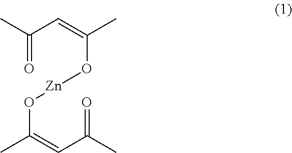

Thiourea (SC(NH₂)₂) is preferably used as the S compound.

Then, a predetermined amount of the core particles and a predetermined amount of the multiple ingredient-containing compounds are weighed out, and these weighed components are mixed together. After nitrogen purging, the dry solvent is added to obtain a mixture solution. Subsequently, the mixture solution is heated at a temperature of about 50° C. for a predetermined time. Thus, a reaction product (core-shell particles) is obtained in which the coating layer 12 having a band gap energy greater than that of the core particles 11 is formed on the surface of each core particle 11.

Then, the reaction product is cooled by being left standing for a predetermined time, followed by centrifugation to separate the supernatant from the precipitate so as to remove coarse particles by a method and a procedure substantially similar to those in the first embodiment. The supernatant is collected, and the precipitate is discarded. A poor solvent such as methanol, ethanol, acetone, or acetonitrile is added to the supernatant to form a precipitate, followed by re-centrifugation. The supernatant is discarded, and the precipitate is collected by separation.

The operation sequentially including addition of a poor solvent, centrifugation, and collection of the precipitate is preferably repeated several times as in the first embodiment, whereby coarse particles and the like are removed, making is possible to produce a precipitate of ultrafine particles free of impurities of foreign phases and the like.

Then, the precipitate is dried in the air and subsequently dissolved in a non-polar solvent such as chloroform, toluene, hexane, or the like, whereby the core-shell structured semiconductor nanoparticles are stably dispersed in the non-polar solvent. Thus, a nanoparticle dispersion (core-shell particle dispersion) according to the second embodiment can be produced.

The core-shell structure of the semiconductor nanoparticles of the present embodiment can be confirmed by detecting shell material components by compositional analysis, observing individual core particles 11 and individual semiconductor nanoparticles of the present embodiment with an electronic microscope, and comparing the average particle size between these particles. The core-shell structure can also be confirmed with an electronic microscope by element analysis at regular intervals in a straight line from one end of individual semiconductor nanoparticles produced.

Specifically, in the core-shell structured semiconductor nanoparticles, a large amount of shell components is detected at and near the end of each semiconductor nanoparticle, and a large amount of core components is detected at and around the center thereof. Thus, the core-shell structure can also be confirmed by such element analysis.

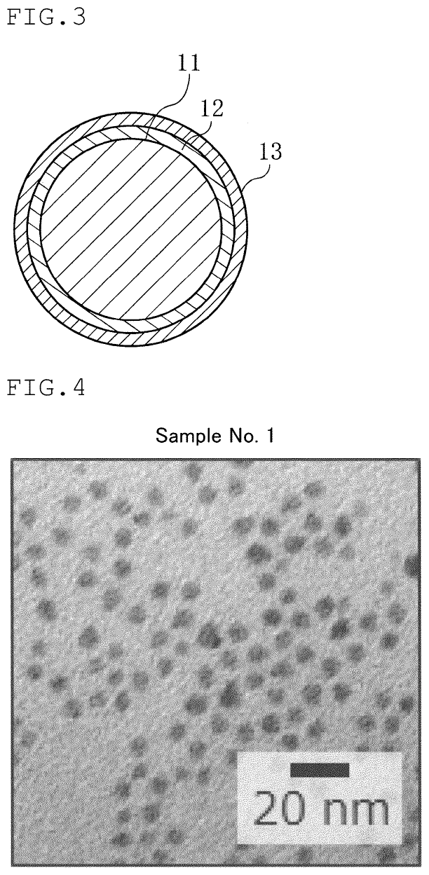

FIG. 3 is a schematic view of a semiconductor nanoparticle as a modified example of the second embodiment.

In this modified example, multiple coating layers 12 and 13 are formed in a layered form on the surface of each core particle 11, thus forming a core-shell-shell structure. The coating layers 12 and 13 each may be made of any material as long as it has a band gap energy greater than the band gap energy of the core particles 11. These layers can be made of the same material or different materials.

When the multiple coating layers 12 and 13 are formed on the surface of each core particle 11 as described above, the core particle 11 is covered with a high dense coating. This can further inactivate the surface, further reduce the energy loss, and further improve the emission properties. In FIG. 3, two layers consisting of the coating layers 12 and 13 are formed on the surface of the core particle 11, but forming multiple coating layers including three or more layers is also preferred.

A light-emitting body containing the semiconductor nanoparticles of the present embodiment also emits light in the near infrared region with a wavelength of 700 to 1000 nm as in the first embodiment and thus can be suitably applied, as a biological substance labeling agent, to bioimaging technology.

The present disclosure is not limited by the above embodiments. The embodiment is an embodiment of the present disclosure and may be suitably modified without departing from the gist of the present disclosure. For example, as long as the semiconductor nanoparticles (core particles) are made of a compound semiconductor mainly containing a Ag component, a Ge component, and a S component and the molar ratio of Ag/Ge and the average particle size satisfy the predetermined ranges described above, substances that are inevitably mixed during the production process are not excluded, and the semiconductor nanoparticles may contain optional additives that do not affect the properties.

As described above, the light-emitting body containing the semiconductor nanoparticles of the present embodiment can be used as a biological substance labeling agent and can also be used as a light source to excite labels in-vivo. For example, when the semiconductor nanoparticles of the present embodiment is introduced into a portion where a blue light emitting diode or an ultraviolet light emitting diode is sealed, the semiconductor nanoparticles of the present disclosure are excited by the blue light emitting diode or the ultraviolet light emitting diode and emit light in the near infrared region of 700 to 1400 nm, so that the semiconductor nanoparticles can be used as light to excite labels in-vivo in such a wavelength region.

Further, the semiconductor nanoparticles of the present embodiment can also be used in sensitizing filters for increasing the sensitivity of infrared cameras and can contribute to improving the sensitivity of infrared cameras.

In the second embodiment, the emission properties are improved by forming the coating layer on the surface of each core particle, but the emission properties can also be improved by capping the surface of each core particle with a surface protective agent to remove as many surface defects as possible.

Next, Examples of the present disclosure are specifically described.

### Example 1

### (Production of Samples)

### (Sample No. 1)

First, germanium glycolate (Ge(OCH₂COO)₂(H₂O)₂) to serve as a Ge source was produced. Specifically, glycolic acid having a purity of 97% (available from FUJIFILM Wako Pure Chemical Corporation) and germanium (iv) oxide having a purity of 99.99% (available from Kojundo Chemical Lab. Co., Ltd.) were provided.

Then, the glycolic acid (1.25 g) and the germanium (iv) oxide (0.5 g) were weighed out. These weighed components were fed together with ultrapure water (25 cm³) and a stirrer bar into a three-neck flask, followed by heating in an oil bath at 100° C. for one hour under stirring with a magnetic stirrer, whereby a colorless and transparent mixture solution was obtained. Then, the mixture solution was evaporated and dried, whereby germanium glycolate was obtained.

Next, AgDDTC (Dojindo Laboratories) as a Ag source, thiourea having a purity of 98% (available from Tokyo Chemical Industry Co., Ltd.) as a S source, oleylamine having a purity of 50% (available from Tokyo Chemical Industry Co., Ltd.) as a solvent, and 1-dodecanethiol having a purity of 98% (available from FUJIFILM Wako Pure Chemical Corporation) as a solvent were provided.

Then, AgDDTC (0.075 mmol), germanium glycolate (0.046 mmol), and thiourea (0.100 mmol) were collected into a test tube. The test tube was further charged with oleylamine (2.75 cm³) and 1-dodecanethiol (0.25 cm³) together with a stirrer bar, and the mixture was stirred, whereby a Ag—Ge—S mixture solution was produced.

Next, the inside of the test tube was vacuum degassed, followed by nitrogen purging and heating at a reaction temperature of 200° C. for 10 minutes under stirring with a magnetic stirrer, whereby a dark brown suspension (reaction product) was obtained.

Then, the suspension was air-cooled to room temperature, followed by centrifugation at a rotation speed of 4000 rpm for 5 minutes to separate the supernatant from the precipitate. The supernatant was collected, and the precipitate was discarded. Next, to the collected supernatant was added methanol (3 cm³), followed by re-centrifugation at a rotation speed of 4000 rpm for 5 minutes to separate the supernatant from the precipitate, and the supernatant was discarded. To the resulting precipitate was added ethanol (3 cm³), followed by re-centrifugation at a rotation speed of 4000 rpm for 5 minutes to separate the supernatant from the precipitate, and the supernatant was discarded. Then, the resulting precipitate was re-dispersed in chloroform (purity 99.5%, available from Tokyo Chemical Industry Co., Ltd.) as a non-polar solvent, whereby a sample (nanoparticle dispersion) of sample No. 1 was produced.

Then, after evaporating the solvents, the composition of the sample of sample No. 1 was analyzed using a scanning electron microscope-energy dispersive X-ray (hereinafter, “SEM-EDX”) spectrometer (EMAX Energy available from Horiba, Ltd.). As a result, the empirical formula was Ag_{38.2}Ge_{21.2}S_{40.6}, and the molar ratio of Ag/Ge was 1.8.

### (Sample No. 2)

A sample of sample No. 2 was produced by a method and a procedure similar to those in sample No. 1, except for weighing out AgDDTC in an amount of 0.025 mmol, germanium glycolate in an amount of 0.043 mmol, and thiourea in an amount of 0.100 mmol. Then, after evaporating the solvents, the composition of the sample of sample No. 2 was analyzed using a SEM-EDX spectrometer as in sample No. 1. As a result, the empirical formula was Ag_{42.9}Ge_{12.7}S_{44.4}, and the molar ratio of Ag/Ge was 3.4.

### (Sample No. 3)

A sample of sample No. 3 was produced by a method and a procedure similar to those in sample No. 1, except for weighing out AgDDTC in an amount of 0.050 mmol, germanium glycolate in an amount of 0.0375 mmol, and thiourea in an amount of 0.100 mmol. Then, after evaporating the solvents, the composition of the sample of sample No. 3 was analyzed using a SEM-EDX spectrometer as in sample No. 1. As a result, the empirical formula was AAg_{47.5}Ge_{12.4}S_{12.4}, and the molar ratio of Ag/Ge was 3.8.

### (Sample No. 4)

A sample of sample No. 4 was produced by a method and a procedure similar to those in sample No. 1, except for weighing out AgDDTC in an amount of 0.100 mmol, germanium glycolate in an amount of 0.025 mmol, and thiourea in an amount of 0.100 mmol. Then, after evaporating the solvents, the composition of the sample of sample No. 4 was analyzed using a SEM-EDX spectrometer as in sample No. 1. As a result, the empirical formula was Ag_{48.3}Ge_{11.6}S_{40.1}, and the molar ratio of Ag/Ge was 4.2.

### (Sample No. 5)

A sample of sample No. 5 was produced by a method and a procedure similar to those in sample No. 1, except for weighing out AgDDTC in an amount of 0.010 mmol, germanium glycolate in an amount of 0.0475 mmol, and thiourea in an amount of 0.100 mmol. Then, after evaporating the solvents, the composition of the sample of sample No. 5 was analyzed using a SEM-EDX spectrometer as in sample No. 1. As a result, the empirical formula was Ag_{37.8}Ge_{8.73}S_{53.5}, and the molar ratio of Ag/Ge was 4.3.

### (Sample No. 6)

A sample of sample No. 6 was produced by a method and a procedure similar to those in sample No. 1, except for weighing out AgDDTC in an amount of 0.133 mmol, germanium glycolate in an amount of 0.017 mmol, and thiourea in an amount of 0.100 mmol. Then, after evaporating the solvents, the composition of the sample of sample No. 6 was analyzed using a SEM-EDX spectrometer as in sample No. 1. As a result, the empirical formula was Ag_{51.3}Ge_{7.01}S_{38.0}, and the molar ratio of Ag/Ge was 7.3.

### (Sample No. 7)

A dark brown suspension was obtained by a method and a procedure similar to those in sample No. 1, except for weighing out AgDDTC in an amount of 0.133 mmol, germanium glycolate in an amount of 0.017 mmol, and thiourea in an amount of 0.100 mmol. Then, the suspension was air-cooled to room temperature, followed by centrifugation at a rotation speed of 4000 rpm for 5 minutes to separate the supernatant from the precipitate. The supernatant was discarded, and the precipitate was collected. Next, to the collected precipitate was added methanol (3 cm³), followed by re-centrifugation at a rotation speed of 4000 rpm for 5 minutes to separate the supernatant from the precipitate, and the supernatant was discarded. To the resulting precipitate was added ethanol (3 cm³), followed by re-centrifugation at a rotation speed of 4000 rpm for 5 minutes to separate the supernatant from the precipitate, and the supernatant was discarded. The resulting precipitate was re-dispersed in chloroform, whereby a sample of sample No. 7 was produced.

Then, after evaporating the solvents, the composition of the sample of sample No. 7 was analyzed using a SEM-EDX spectrometer as in sample No. 1. As a result, the empirical formula was Ag_{54.5}Ge_{7.30}S_{38.0}, and the molar ratio of Ag/Ge was 7.5.

### (Sample No. 8)

A production of nanoparticles represented by an empirical formula of Ge₂S was attempted by a method and a procedure similar to those in sample No. 1, except for weighing out germanium glycolate in an amount of 0.050 mmol and thiourea in an amount of 0.100 mmol and not adding AgDDTC to a sample. After a reaction product of germanium glycolate and thiourea was centrifuged in a similar manner described above, an attempt was made to disperse the resulting substance in chloroform, but only a trace amount of white particles was observed as described later. This sample was regarded as sample No. 8.

### (Sample No. 9)

A sample of sample No. 9 was produced by a method and a procedure similar to those in sample No. 1, except for weighing out AgDDTC in an amount of 0.200 mmol and thiourea in an amount of 0.100 mmol and not adding germanium glycolate to the sample.

### Sample Evaluation

### (Particle Size Measurement)

TEM images of the samples of sample Nos. 1 to 6 and 9 were taken using a transmission electron microscope (hereinafter, “TEM”) (H-7650 available from Hitachi High-Tech Corporation), and 100 particles were randomly selected to measure their areas. Then, the equivalent circle diameter of each particle was calculated from the measurements, and the arithmetic mean was obtained, whereby the average particle size was determined. Further, the difference between the maximum particle size Dmax and the minimum particle size Dmin was determined. No formation of nanoparticles was observed in sample No. 8, so that the particle size could not be measured.

### (Measurement of Absorption Spectrum, Emission Spectrum, and Quantum Yield)

The absorption spectrum of each of the samples of sample Nos. 1 to 6 was measured using a diode array spectrophotometer (8453a available from Agilent Technologies, Inc.).

The emission spectrum and the emission quantum yield of each of the samples of sample Nos. 1 to 6 were measured at room temperature of 25° C. using an absolute emission quantum yield measuring spectrometer (C9920-03 available from Hamamatsu Photonics K.K.). Further, the emission quantum yield of the sample of sample No. 7 was measured using the absolute emission quantum yield measuring spectrometer.

### (Evaluation of Measurement Results)

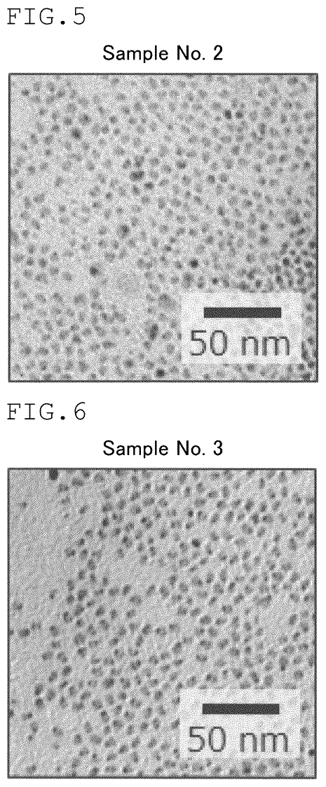

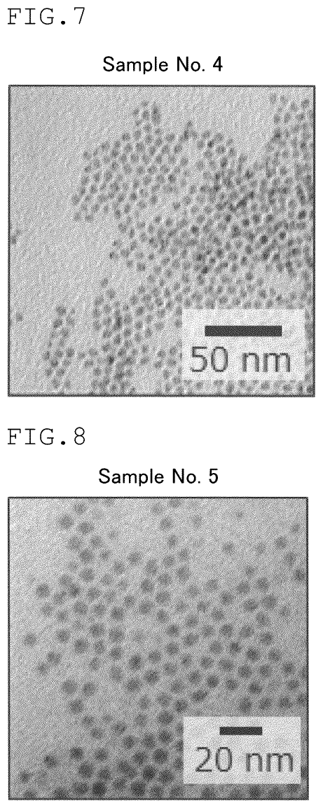

FIG. 4 to FIG. 10 are TEM images of sample Nos. 1 to 6 and 9.

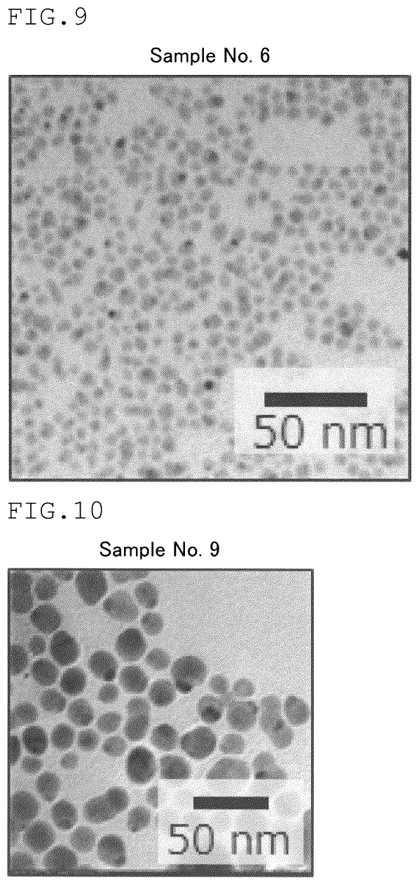

In sample No. 9 containing no Ge component, as shown in FIG. 10, coarse semiconductor particles having a particle size of more than 10 nm were obtained. In contrast, in sample Nos. 1 to 6 each containing a Ge component, as shown in FIG. 4 to FIG. 9, semiconductor particles in the form of uniformly or substantially uniformly dispersed nanoparticles with reduced variation in particle size were obtained. Specifically, in the Ag—Ge—S-based compound semiconductor, the Ge component was found to contribute to formation of nanoparticles.

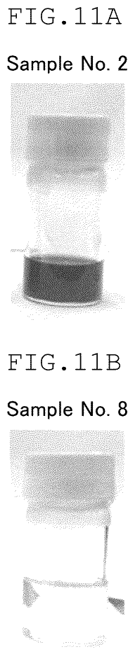

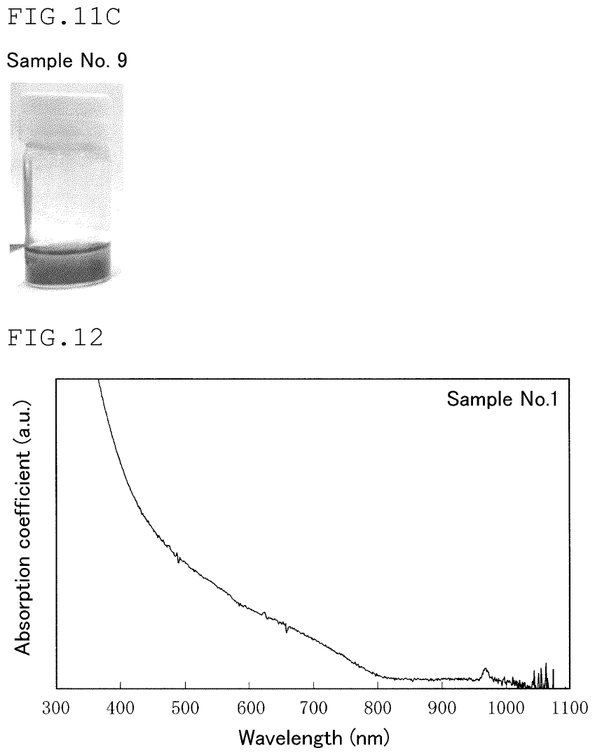

FIGS. 11A to 11C are views showing the reaction product being dispersed in chloroform, with FIG. 11A showing sample No. 2, FIG. 11B showing sample No. 8, and FIG. 11C showing sample No. 9.

Sample No. 8 contained no Ag component, and a reaction merely occurred between germanium glycolate and thiourea. Thus, as shown in FIG. 11B, only a small amount of white ultrafine particles was observed, confirming no formation of a precipitate and no formation of nanoparticles.

Sample No. 9 was obtained in the form of black particles by reacting AgDTTC with thiourea. The black particles were dispersed in chloroform but immediately precipitated as shown in FIG. 11C.

In contrast, sample No. 2 was obtained in the form of a dark brown precipitate dispersed in chloroform as shown in FIG. 11A. Although the drawings are omitted, similar dark brown precipitates were obtained in sample Nos. 1 and 3 to 7.

Table 1 shows the empirical formula, molar ratio of Ag/Ge, average particle size, difference between the maximum particle size Dmax and the minimum particle size Dmin, and emission quantum yield of each of the samples of sample Nos. 1 to 9. For sample Nos. 8 and 9, Table 1 shows empirical formulas of the compounds intended to be produced.

TABLE 1

| | | | | Difference between | |
|---|---|---|---|---|---|
| | | Molar | Average | maximum particle size and | |
| Sample | | ratio | particle | minimum particle size | Quantum |
| No. | Empirical formula | Ag/Ge | size (nm) | Dₘₐₓ − Dₘᵢₙ (nm) | yield (%) |
| 1 | Ag_{38.2}Ge_{21.2}S_{40.6} | 1.8 | 7.0 | 2.6 | 0.7 |
| 2 | Ag_{42.9}Ge_{12.7}S_{44.4} | 3.4 | 5.7 | 1.8 | 1.1 |
| 3 | Ag_{47.5}Ge_{12.4}S_{12.4} | 3.8 | 6.2 | 2.4 | 0.8 |
| 4 | Ag_{48.3}Ge_{11.6}S_{40.1} | 4.2 | 5.2 | 1.8 | 1.2 |
| 5 | Ag_{37.8}Ge_{8.73}S_{53.5} | 4.3 | 6.6 | 1.6 | 1.1 |
| 6 | Ag_{51.3}Ge_{7.01}S_{38.2} | 7.3 | 6.2 | 1.8 | 0.8 |
| 7* | Ag_{54.5}Ge_{7.30}S_{38.2} | 7.5 | — | — | 0.4 |
| 8* | (GeS₂) | 0 | No formation of nanoparticles | | — |
| 9* | (Ag₂S) | — | 17.4 | — | — |

*Outside the range of the present disclosure

Sample No. 9 contained no Ge component, so that the particles were coarsened as described above, with the average particle size being far beyond 9 nm and reaching 17.4 nm. The particle size also varied greatly, with the difference between the maximum particle size Dmax and the minimum particle size Dmin being 5.8 nm. This shows that a sufficient quantum size effect may not be obtained.

Similarly to sample Nos. 1 to 6 described above, sample No. 7 was obtained in the form of a dark brown precipitate. However, due to a molar ratio of Ag/Ge being 7.5 and a large molar amount of the Ag component relative to the Ge component, the emission quantum yield was as low as 0.4%, showing inability to achieve sufficient emission efficiency.

In contrast, in sample Nos. 1 to 6, the molar ratio of Ag/Ge was 1.8 to 7.3 as shown in Table 1, which is within the range specified in the present disclosure. This makes it possible to form 9 nm or smaller nanoparticles having an average particle size of 6.2 to 7.0 nm. The difference between the maximum particle size and the minimum particle size was 1.6 to 2.6 nm, which shows that the difference can be controlled to 3 nm or less. As shown in Table 1, the emission quantum yield was 0.7 to 1.2%. This shows that it is possible to achieve an emission quantum yield of 0.5% or more.

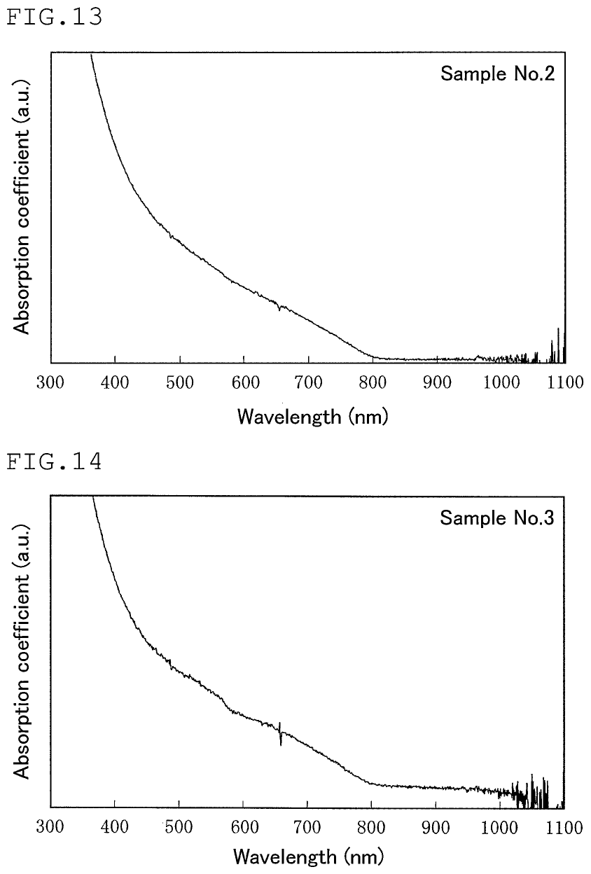

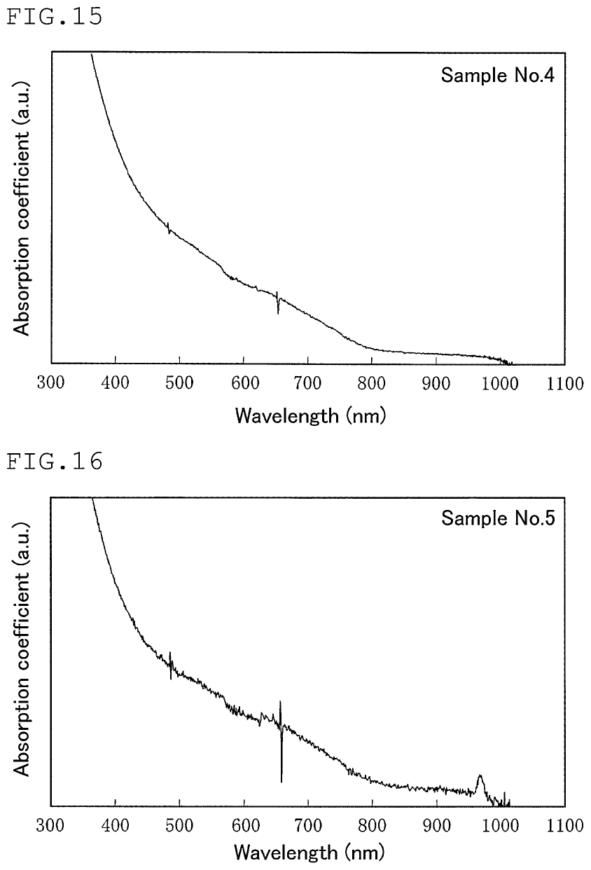

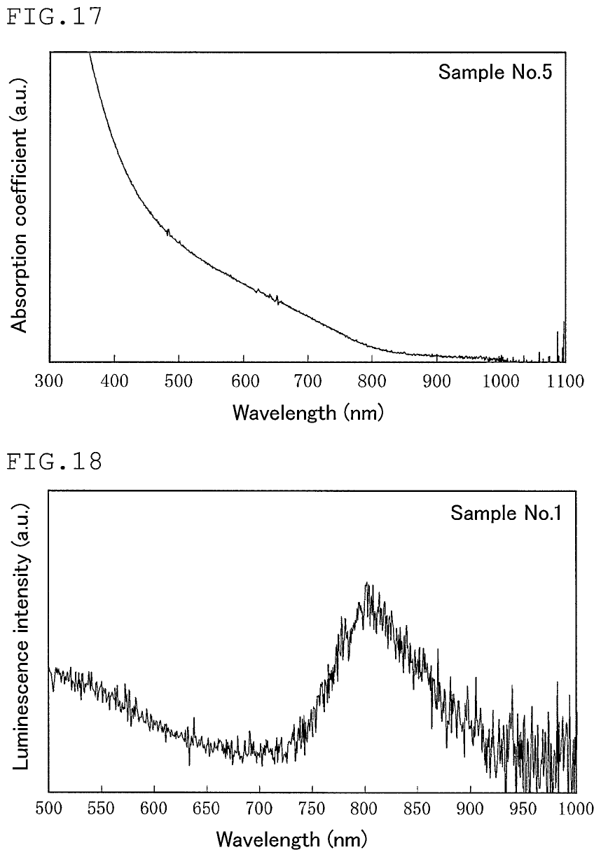

FIG. 12 to FIG. 17 are absorption spectra of the samples of samples Nos. 1 to 6. The horizontal axis is the wavelength (nm) and the vertical axis is the absorption coefficient (a.u.). In each absorption spectrum, the absorption coefficient on the vertical axis was normalized to the same standard to allow evaluations to be made while comparing the properties of each sample.

As is clear from FIG. 12 to FIG. 17, the samples 1 to 6 have similar properties. Specifically, as the wavelength increases, the absorption coefficient decreases while drawing a continuous curve. The wavelength at each falling tail is about 800 nm. Thus, presumably, such a wavelength corresponds to an absorption edge wavelength.

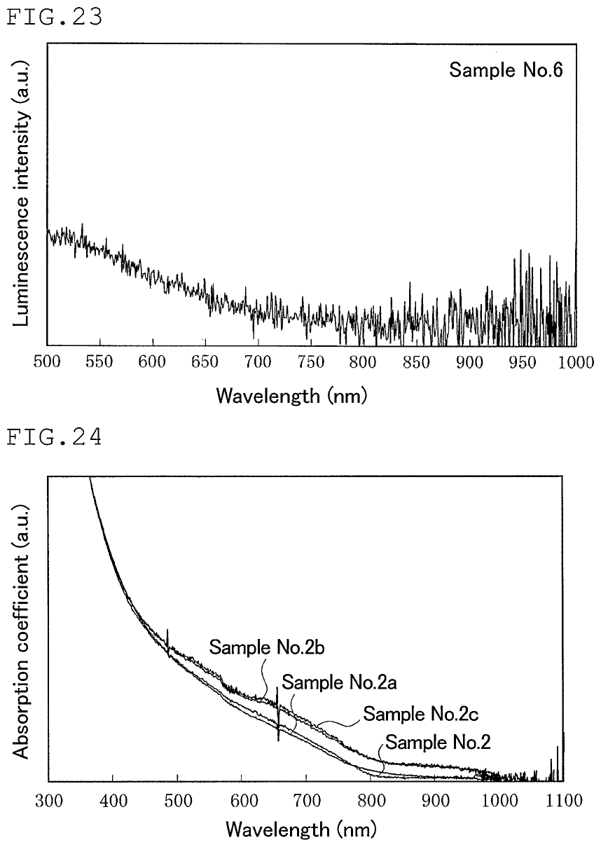

FIG. 18 to FIG. 23 include emission spectra of the samples of sample Nos. 1 to 6. The horizontal axis is the wavelength (nm) and the vertical axis is the emission intensity (a.u.). Also in each emission spectrum, similarly to the absorption spectra, the emission intensity on the vertical axis is normalized to the same standard to allow evaluations to be made while comparing the properties of each sample.

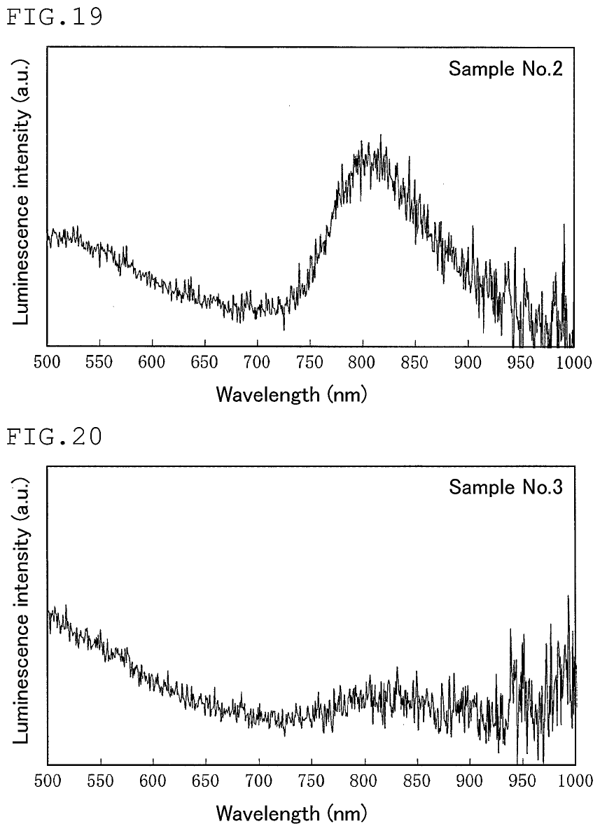

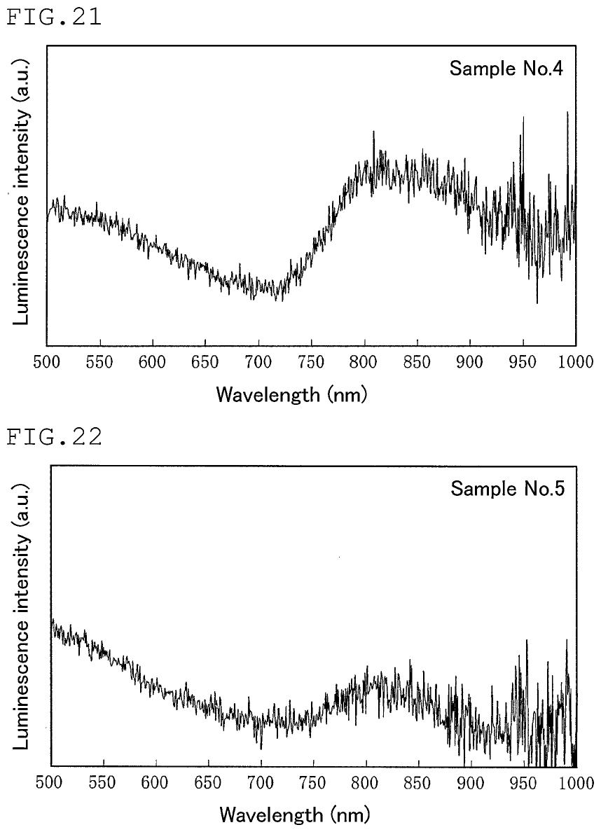

FIG. 18 to FIG. 23 clearly show that the sample Nos. 1 to 6 emit light in the wavelength range from the absorption edge to the side with a longer wavelength than the absorption edge and not higher than 1000 nm. In particular, in each of sample Nos. 1, 2, and 4 (FIG. 18, FIG. 19, and FIG. 21), a mountain-like peak of the emission intensity was observed around 820 to 850 nm near the absorption edge wavelength.

Based on the above, even a Ag—Ge—S-based compound semiconductor not containing Cd, Se, In, or other like components is capable of emitting light in the near infrared region of 700 to 1000 nm when the molar ratio of Ag/Ge in the compound semiconductor and the average particle size are specified, and is capable of exhibiting the quantum size effect because the average particle size is 9 nm or less. This shows that it is possible to obtain semiconductor nanoparticles that are highly safe and easy to handle and that are applicable to various fields.

### Example 2

Samples were produced by varying the reaction temperature during synthesis, and properties of each sample were evaluated. Specifically, similarly to sample No. 2, each sample was produced by a method and a procedure similar to those in sample No. 1, except for weighing out AgDDTC in an amount of 0.025 mmol, germanium glycolate in an amount of 0.043 mmol, and thiourea in an amount of 0.1 mmol, and setting the reaction temperature to 150° C. (sample No. 2a), 220° C. (sample No. 2b), or 250° C. (sample No. 3).

Then, the absorption spectrum and the emission spectrum of each of the samples of sample Nos. 2a to 2c were measured by a method and a procedure similar to those in Example 1.

FIG. 24 includes absorption spectra of the samples No. 2a to 2c. The horizontal axis is the wavelength (nm) and the vertical axis is the absorption coefficient (a.u.). The emission spectrum of sample No. 2 is shown again for comparison.

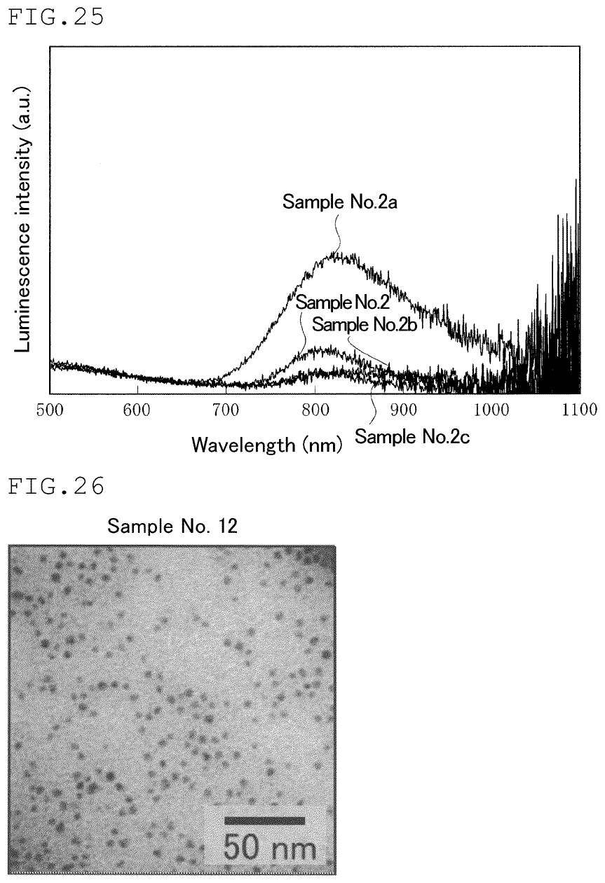

FIG. 25 includes emission spectra of the samples No. 2a to 2c. The horizontal axis is the wavelength (nm) and the vertical axis is the emission intensity (a.u.). The emission spectrum of sample No. 2 is shown again for comparison.

FIG. 24 and FIG. 25 respectively show the absorption coefficient and the emission intensity on the vertical axis, which are normalized to the same standard to allow evaluations to be made while comparing the properties of each sample. Thus, the emission spectrum of sample No. 2 is identical to the emission spectrum of FIG. 19 in terms of properties.

As is clear from FIG. 24, sample Nos. 2a to 2c each have a profile with an absorption edge wavelength of about 800 nm as in sample No. 2.

As shown in FIG. 25, light is emitted in the near infrared region with a wavelength of 700 to 1000 nm in each of sample Nos. 2a to 2c, and 2. In particular, sample No. 2a in which the reaction temperature was 150° C. exhibits an emission intensity with a prominent mountain-like peak compared to sample Nos. 2, 2b, and 2c, indicating good emission properties. It was confirmed that setting a reaction temperature to 150° C. as described above allows the semiconductor particle formation reaction to effectively proceed, resulting in especially good emission properties.

### Example 3

A sample (sample No. 12) having a core-shell structure was produced, and its properties were compared against those of the core particle sample (sample No. 11) and evaluated.

### Production of Samples

### (Sample No. 11)

Similarly to sample No. 2, AgDDTC (0.025 mmol), germanium glycolate (0.043 mmol), and thiourea (0.1 mmol) were collected into a test tube. The test tube was further charged with oleylamine (2.75 cm³) and 1-dodecanethiol (0.25 cm³) together with a stirrer bar, whereby a Ag—Ge—S mixture solution was produced.

Next, the inside of the test tube was vacuum degassed, followed by nitrogen purging and heating at a reaction temperature of 150° C. for 20 minutes under stirring with a magnetic stirrer, whereby a dark brown suspension (reaction product) was obtained.

Subsequently, the operation including addition of methanol, centrifugation, and collection of the precipitate was performed by a method and a procedure similar to those used for sample No. 1 in Example 1, and the resulting precipitate was re-dispersed in chloroform, whereby a sample (core particle dispersion) of sample No. 11 was produced.

### (Sample No. 12)

For sample No. 11, a sample with a particle count of 5 nmol was collected into a test tube, and vacuum degassed for about 10 hours.

The oleylamine used as a solvent in Example 1 was stirred under heating at a temperature of 100° C. for one hour while being vacuum degassed, followed by air cooling to room temperature, whereby dry oleylamine was obtained.

Next, a Zn compound and a S compound were provided as ingredient-containing compounds. Here, bis(2,4-pentanedionato)zinc(II) (available from Tokyo Chemical Industry Co., Ltd.) was used as the Zn compound, and thiourea (available from Tokyo Chemical Industry Co., Ltd.) was used as the S compound. Then, bis(2,4-pentanedionato)zinc(II) (2.63 mg) and thiourea (0.75 mg) were added to the test tube containing the sample of sample No. 11, followed by nitrogen purging. Subsequently, the dry oleylamine (3 cm³) was added to the test tube, whereby a mixture solution was obtained. Next, the mixture solution was heated at a heating temperature of 50° C. for 15 minutes, whereby a reaction product was obtained.

Then, the reaction product was cooled by being left standing for 20 minutes, followed by centrifugation at a rotation speed of 4000 rpm for 5 minutes to separate the supernatant from the precipitate. The supernatant was collected, and the precipitate was discarded. Next, to the collected supernatant was added methanol (3 cm³), followed by re-centrifugation at a rotation speed of 4000 rpm for 5 minutes to separate the supernatant from the precipitate, and the supernatant was discarded. To the resulting precipitate was added ethanol 3 cm³, followed by re-centrifugation at a rotation speed of 4000 rpm for 5 minutes to separate the supernatant from the precipitate, and the supernatant was discarded. The resulting precipitate was dried in the air. Subsequently, the resulting precipitate was dispersed in chloroform (2 cm³), whereby a sample (core-shell particle dispersion) of sample No. 12 was produced.

### Evaluation of Samples

FIG. 26 is a TEM image of sample No. 12. As is clear from FIG. 26, in sample No. 12, semiconductor particles in the form of uniformly or substantially uniformly dispersed nanoparticles with reduced variation in particle size were obtained as in sample Nos. 1 to 6.

Similarly to Example 1, TEM images of the samples of sample Nos. 11 and 12 were taken, and 100 particles were randomly selected to measure their areas. The equivalent circle diameter of each particle was calculated from the measurements, and the arithmetic mean was obtained, whereby the average particle size was determined. The standard deviation σ of each sample was also determined.

Then, the composition of each of the samples of sample Nos. 11 and 12 was analyzed using a SEM-EDX spectrometer as in Example 1, whereby the amount of Zn in each sample was determined.

Further, the absorption spectrum, emission spectrum, and emission quantum yield of each of the samples of sample Nos. 11 and 12 were measured by a method and a procedure similar to those in Example 1

Table 2 shows the measurement results.

TABLE 2

| | Average | Standard | Amount | |
|---|---|---|---|---|
| Sample | particle | deviation | of Zn | Quantum |
| No. | size (nm) | σ (nm) | (atom %) | yield (%) |
| 11 | 4.00 | 0.66 | 0 | 3.1 |
| 12 | 4.89 | 0.65 | 26.4 | 5.9 |

The average particle sizes of sample No. 12 and sample No. 11 (not shown) were determined from the respective TEM images. As shown in Table 2, while the average particle size was 4.00 nm in sample No. 11, the average particle size was 4.89 nm in sample No. 12, showing a larger average particle size in sample No. 12 than in sample No. 11. In sample No. 12, the core particle sample of sample No. 11 was blended with bis(2,4-pentanedionato)zinc(II) and thiourea and heated, so that a coating layer was formed on the surface of each core particle. Presumably, this is the reason for the increase in average particle size.

The amounts of the components in sample No. 11 were the same as those in sample No. 2, but due to different reaction conditions, the average particle size in sample No. 11 was 4.00 nm, which is smaller than that in sample No. 2 (5.7 nm). Specifically, in sample No. 2, the reaction was performed at a high reaction temperature of 200° C., which presumably promoted the particle growth, resulting in coarse particles having an average particle size of 5.7 nm. In contrast, in sample No. 11, the reaction was performed at a reaction temperature of 150° C., which presumably prevented excessive particle growth, resulting in ultrafine particles having an average particle size of 4.00 nm.

As shown in Table 2, while the standard deviation σ is 0.66 nm in sample No. 11, it is 0.65 nm in sample No. 12. This shows that sample No. 12 achieved a standard deviation σ almost equivalent to that of sample No. 11.

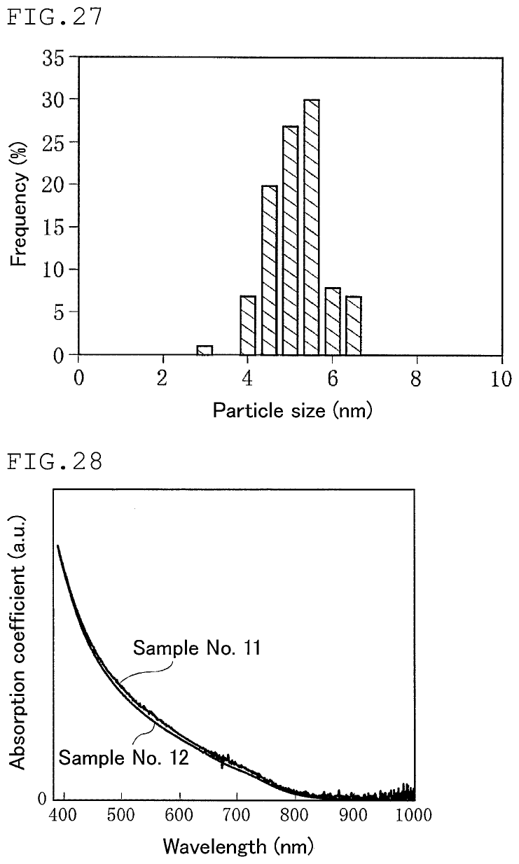

FIG. 27 is a histogram of sample No. 12. In the figure, the horizontal axis is the particle size (nm), and the vertical axis is the frequency (%).

As shown in FIG. 27, the sample of sample No. 12 has a particle size distribution with a mountain-like peak. This shows that spherical particles that were substantially uniformly dispersed were obtained.

According to the results of the compositional analysis of sample No. 12, Ag was 23.5 atom %, Ge was 4.6 atom, Zn was 26.4 atom %, and S was 45.5 atom %. Specifically, the results show that while sample No. 11 was substantially free of a Zn component because no Zn component was contained, sample No. 12 contained a Zn component in an amount of 26.4 atom %. Specifically, the compositional analysis results confirmed that the sample of sample No. 12 consists of semiconductor nanoparticles having a core-shell structure including a core particle and a shell layer (coating layer) made of ZnS on the surface of the core particle.

The molar ratio of Ag/Ge was higher in sample 11 than in sample No. 2, although the amounts of the components were the same therebetween as described above. Specifically, according to the results of the compositional analysis, in sample No. 11, Ag was 32.7 atom %, Ge was 7.9 atom, and S was 59.4 atom %, and the molar ratio of Ag/Ge was 4.1, while in sample No. 2, Ag was 42.9 atom %, Ge was 12.7 atom %, and S was 44.4 atom, and the molar ratio of Ag/Ge was 3.4 (see Example 1 and Table 1). Thus, the molar ratio of Ag/Ge was higher in sample No. 11 than in sample No. 2. Presumably, this is due to heating at a reaction temperature of 150° C. in sample No. 11 in contrast to heating at a reaction temperature of 200° C. in sample No. 2. This also shows that it is possible to control not only the average particle size but also the molar ratio by changing the reaction conditions as described above.

FIG. 28 is a view showing absorption spectrum profiles of sample No. 11 and sample No. 12. They are normalized to the same standard to allow evaluations to be made while comparing the properties of these samples. In the figure, the horizontal axis is the wavelength (nm) and the vertical axis is the absorption coefficient (a.u.).

As is clear from FIG. 28, the absorption spectrum is substantially the same between sample No. 11 and sample No. 12. In particular, there is no difference in properties at or near the absorption edge wavelength of 800 nm. This confirms that the formation of the shell layer (coating layer) does not change the absorption spectrum of the compound semiconductor forming core particles.

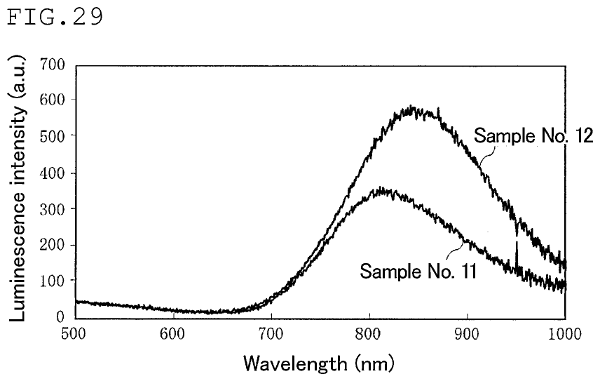

FIG. 29 is a view showing emission spectrum profiles of sample No. 11 and sample No. 12. It is normalized to the same standard to allow evaluations to be made while comparing the properties of these samples. In the figure, the horizontal axis is the wavelength (nm) and the vertical axis is the emission intensity (a.u.).

FIG. 29 clearly shows an improvement in emission intensity in sample No. 12, compared to sample No. 11. As shown in Table 2, the emission quantum yield was increased to 5.9% in sample No. 12, as compared to 3.1% in sample No. 11. Specifically, in sample No. 12, each core particle is covered with ZnS having a band gap energy (about 3.7 eV) greater than the band gap energy (about 1.45 eV) of the Ag—Ge—S-based compound semiconductor of sample No. 11, so that light can be released without loss of emission from the core particles, and in addition, the surface defects on the core particles are covered with the coating layer. This can reduce the surface defects and control the non-radiative deactivation process. This confirmed that it is possible to improve the emission quantum yield and obtain semiconductor nanoparticles with a high emission intensity and improved emission properties.

When semiconductor nanoparticles are made of a Ag—Ge—S-based compound semiconductor having a molar ratio of Ag/Ge of 1.0 or more and less than 7.5, preferably 1.8 or more and less than 7.3, and an average particle size of 9 nm or less, it is possible to provide easy-to-handle semiconductor nanoparticles capable of emitting light in the near infrared region with a wavelength of 700 to 1000 nm, with a low environmental impact and without requiring special attention to toxic control and health management of manufacturing workers. The semiconductor nanoparticles are applicable to various industrial fields such as biological substance labeling agents and light sources in bioimaging technology, and intensifying filters for infrared cameras. A light-emitting body with a higher emission efficiency can be achieved with such semiconductor nanoparticles formed in the core-shell structure.

### REFERENCE SIGNS LIST

11 semiconductor nanoparticle, core particle
12 coating layer
13 coating layer

1. Semiconductor nanoparticles comprising:
a compound semiconductor mainly containing a Ag component, a Ge component, and a S component,
wherein a content ratio of the Ag component to the Ge component is 1.0 or more and less than 7.5 in terms of molar ratio, and
an average particle size of the semiconductor nanoparticles is 9 nm or less.

2. The semiconductor nanoparticles according to claim 1, wherein the content ratio of the Ag component to the Ge component is 1.8 or more and 7.3 or less.

3. The semiconductor nanoparticles according to claim 1, wherein a difference between a maximum particle size and a minimum particle size of the semiconductor nanoparticles is 3 nm or less.

4. The semiconductor nanoparticles according to claim 1, wherein the semiconductor nanoparticles are arranged to emit light in a wavelength range of 700 to 1000 nm.

5. The semiconductor nanoparticles according to claim 1, wherein the semiconductor nanoparticles have a core-shell structure including a core particle comprising the compound semiconductor and a coating layer comprising a material having a band gap energy greater than that of the compound semiconductor on a surface of the core particle.

6. The semiconductor nanoparticles according to claim 5, wherein the material of the coating layer comprises a compound mainly containing at least one element Z1 selected from the group consisting of elements of Group 12, Group 13, and Group 14 of the periodic table and at least one element Z2 selected from the group consisting of elements of Group 16 of the periodic table.

7. The semiconductor nanoparticles according to claim 6, wherein the element Z1 includes at least one selected from the group consisting of Zn, Ga, Sn, and Ge.

8. The semiconductor nanoparticles according to claim 6, wherein the element Z2 includes at least one selected from the group consisting of S and O.

9. The semiconductor nanoparticles according to claim 5, wherein the coating layer includes multiple coating layers in a layered form on the surface of each of the semiconductor nanoparticles.

10. A method for producing semiconductor nanoparticles, the method comprising:
weighing a Ag compound, a Ge compound, and a S compound such that a content ratio of the Ag component to the Ge component in a compound semiconductor of the semiconductor nanoparticles to be produced is 1.0 or more and less than 7.5 in terms of molar ratio;
dissolving the weighed compounds in a solvent so as to produce a Ag—Ge—S mixture solution; and
heating the Ag—Ge—S mixture solution at a reaction temperature of 150° C. or higher and lower than 250° C. so as to synthesize the semiconductor nanoparticles having an average particle size of 9 nm or less.

11. The method for producing semiconductor nanoparticles according to claim 10, wherein the reaction temperature is 220° C. or lower.

12. The method for producing semiconductor nanoparticles according to claim 10, further comprising dispersing the semiconductor nanoparticles in a non-polar solvent.

13. The method for producing semiconductor nanoparticles according to claim 12, wherein the non-polar solvent is chloroform.

14. The method for producing semiconductor nanoparticles according to claim 10, wherein the Ag compound includes silver N,N-diethyldithiocarbamate.

15. The method for producing semiconductor nanoparticles according to claim 10, wherein the Ge compound includes a reaction product of a hydroxy acid and a germanium oxide.

16. The method for producing semiconductor nanoparticles according to claim 15, wherein the hydroxy acid includes glycolic acid.

17. The method for producing semiconductor nanoparticles according to claim 10, wherein the S compound includes thiourea.

18. The method for producing semiconductor nanoparticles according to claim 10, wherein the solvent includes a combination of an aliphatic amine and a lipid-soluble thiol, the combination having a boiling point higher than the reaction temperature.

19. The method for producing semiconductor nanoparticles according to claim 18, wherein the aliphatic amine includes oleylamine.

20. The method for producing semiconductor nanoparticles according to claim 18, wherein the lipid-soluble thiol includes 1-dodecanethiol.

21. The method for producing semiconductor nanoparticles according to claim 10, further comprising forming a coating layer having a band gap energy greater than that of the compound semiconductor using multiple ingredient-containing compounds by mixing and heating the compound semiconductor and the multiple ingredient-containing compounds to form a coating layer on a surface of a core particle comprising the compound semiconductor so as to produce core-shell structured semiconductor nanoparticles.

22. The method for producing semiconductor nanoparticles according to claim 21, wherein the multiple ingredient-containing compounds include a Z1 compound containing at least one element Z1 selected from the group consisting of elements of Group 12, Group 13, and Group 14 of the periodic table and a Z2 compound containing at least one element Z2 selected from the group consisting of elements of Group 16 of the periodic table.

23. The method for producing semiconductor nanoparticles according to claim 22, wherein the Z1 compound includes a Zn compound, and the Z2 compound includes a S compound.

24. The method for producing semiconductor nanoparticles according to claim 23, wherein the Zn compound includes bis(2,4-pentanedionato)zinc(II).

25. The method for producing semiconductor nanoparticles according to claim 23, wherein the S compound includes thiourea.

26. The method for producing semiconductor nanoparticles according to claim 21, further comprising dispersing the core-shell structured semiconductor nanoparticles in a non-polar solvent.

27. The method for producing semiconductor nanoparticles according to claim 26, wherein the non-polar solvent is chloroform.

28. A light-emitting body comprising the semiconductor nanoparticles according to claim 1.
